(19) United States
(12) Patent Application Publication
(10) Pub. No.: US 2006/0143833 A1
(43) Pub. Date: Jul. 6, 2006

(54) Leather degreasing agent

(75) Inventors: Philippe Lamalle, Lambsheim (DE); Thomas Fungerlings, Weisenheim (DE); Martin Scholtissek, Mannheim (DE); Jurgen Tropsch, Romerberg (DE); Alfred Ruland, Schriesheim (DE); Roland Bohn, Fubgonheim (DE); Gunter Oetter, Frankenthal (DE); Claus Hackmann, Kirchheim (DE); Gunther Pabst, Mannheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Basf Aktiengesellschaft, Ludwigshafen (DE)

(21) Appl. No.: 10/484,203

(22) PCT Filed: Jul. 1, 2002
(86) PCT No.: PCT/EP02/07245

§ 371 Date: Jun. 7, 2004

(30) Foreign Application Priority Data
Jul. 20, 2001 (DE) 101 34 441.4

(51) Int. Cl. C14C 1/00

(52) U.S. Cl. 8/94.15

(57) ABSTRACT

The invention relates to a degreaser for treating hides, skins, pelts and other intermediates in leather and fur manufacture and also wool or related proteinaceous materials that is based on nonionic surfactants of the type of alcohol alkoxylates, comprising alcohol alkoxylates obtained by reaction of at least one alcohol ROH with n mol of at least one alkylene oxide per mole of alcohol ROH, where
R is an alkyl radical of 5 to 30 carbon atoms which has a main chain, of 4 to 29 carbon atoms that has at least one C₁— to C₁₀-alkyl branch attached in the chain middle; the alkylene oxide has 2 to 6 carbon atoms, and n is an integer from 1 to 100. The invention further relates to a process for degreasing hide, skins, pelts and other intermediates of leather and fur manufacture and wool or related proteinaceous materials, which comprises using a degreaser according to the present invention, and to the use of the degreasers.

This invention relates to degreasers for treating hides, skins, pelts and other intermediates of leather and fur manufacture and also wool or related proteinaceous materials that are based on nonionic surfactants of the type of the alcohol alkoxylates, a process for degreasing hides, skins, pelts and other intermediates of leather and fur manufacture and also wool or related proteinaceous materials, and also the use of the degreasers.

The removal of natural fat from animal hides is essential for the manufacture of high quality leathers and furs, especially in the case of animal hides having a medium or high natural fat content. The distribution of finishing chemicals in the post-degreasing stages of leather and fur manufacture is substantially improved by degreasing, enabling uniform tanning and dyeing for example. If the natural fat is not removed, the end product in the case of leather will be spotty and/or acquire fatty spews due to bacterial degradation of the fat and crystallization of the high molecular weight saturated fatty acids during storage that may adversely affect the leather both visually and physically. In the case of furs, the suede side will be unevenly colored and there may additionally be local hard spots with the fur leather at risk of cracking.

Furthermore, the isolation of fats, especially lanolin, from wool or structurally related proteinaceous materials containing these substances requires as complete a degrease as possible.

The art essentially utilizes two processes for degreasing animal hides: solvent degreasing and emulsifier degreasing.

Solvent degreasing is degreasing by means of organic solvents. It can be effected either without added water (dry degreasing) or in the presence of water (wet degreasing). The use of organic solvents means that solvent degreasing has appreciable adverse environmental consequences which are no longer acceptable in many countries even now.

It is these predominantly ecological reasons which are behind the overwhelming preference these days for emulsifier degreasing, where the use of organic solvents is completely dispensed with. Useful emulsifiers for this process include in particular nonionic surfactants, since they have no affinity for the hide or leather fiber. They are thus able to provide optimum solubilization of the natural fat of the animal hides without being impaired by interactions with the animal hide. Known nonionic emulsifiers include addition compounds of ethylene oxide and of propylene oxide with alkylphenols, alcohols or fatty acids. Alkylphenol ethoxylates have been the most widely used nonionic surfactants for decades, especially nonylphenol ethoxylate having on average 10 EO (ethylene oxide) units. True, nonylphenol ethoxylate does give a satisfactory performance with regard to the degreasing of animal hides, but there are ecological and toxicological reservations about the surfactant class of the alkylphenol ethoxylates, so that there is a voluntary ban on the use of alkylphenol ethoxylates in Germany and some other countries.

The replacements for the alkylphenol ethoxylates are predominantly alcohol ethoxylates.

DE-A 42 07 806 and DE-A 43 01 553 disclose fatty alcohol alkoxylate degreasers comprising a blend of predominantly saturated C₁₂ to C₁₈-fatty alcohol ethoxylates having on average more than 6 EO units in the molecule and of a minor amount of shorter-chain, first-cut fatty alcohol ethoxylates having not more than 3 EO units in the molecule. The disclosed fatty alcohol ethoxylates are preferably straight-chain.

EP-A 0 448 948 discloses a process for manufacturing leathers and furs by utilizing surfactants comprising a mixture of a C₁₀- to C₁₈-alkyl/alkylene polyglycol ether having 3 to 10 EO units in the molecule, a C₈- to C₁₈-alkanol/alkenol and an anionic surfactant or surfactant mixture. Degreasing is achieved with minimal foaming, if any.

WO 94/11331 and WO 94/11330 concern the use of 2-propylheptanol having various degrees of alkoxylation in detergent compositions for degreasing hard surfaces and for cleaning textiles. The alkoxides used therein are ethylene oxide (EO) and also mixtures of EO with propylene oxide (PO) or butylene oxide (BuO). Unlike alkoxylates based on C₈- to C₁₁-alcohols, 2-propylheptanol alkoxylates are notable for low foaming in particular.

Möhle and Ohlerich in “Effective Alternatives to Nonylphenol Ethoxylates and Isotridecyl Alcohol Ethoxylates”, More Care, More Ingredients—symposium in print; Seifen, Fette, Öle, Wachse (SÖFW-Journal) volume 127, 6, 2001, pages 26 to 31, report an investigation of the surface activity of alcohol ethoxylates based on isoundecyl alcohols having degrees of ethoxylation of from 6 to 15, especially 7, with the main isomers trimethyl-1-octanol and dimethyl-1-nonanol and isotridecyl alcohols with degrees of ethoxylation of from 5 to 12, especially 8, with the main isomers tetramethyl-1-nonanol, trimethyl-1-decanol and trimethyl-1-nonanol compared with nonylphenol ethoxylates having degrees of ethoxylation of from 6 to 12, especially 9. They determined that the isoundecyl and isotridecyl alcohol ethoxylates lower the surface tension in aqueous solutions in the same order of magnitude as the nonylphenol ethoxylates. However, suitable alternatives to nonylphenol ethoxylates as leather degreasers have not been proposed to date.

The alcohol alkoxylates proposed in WO 94/11331 and WO 94/11330 and Möhle et al. are used therein for cleaning hard surfaces and in textile cleaning. The decisive criterion in this case is how good the wetting by the detergent is; that is, how well the surfactants used are capable of lowering the surface tension of the aqueous solutions. In the degreasing of natural materials such as leather, fat and wool, however, degreasing is a two step process:
a) the fat is dissolved,
b) the dissolved fat is transported out of the interior of the collagen matrix of the leather or out of the wool.

The surfactants used in the degreasing according to the invention therefore have to perform both functions a) and b).

However, many of the surfactants ordinarily used in detergents do not meet these high requirements. The alcohol alkoxylates used in the prior art which do meet these requirements as well as the alkylphenol ethoxylates customarily used are frequently more costly than the alkylphenol ethoxylates and/or frequently have lower degreasing power.

It is an object of the present invention to provide an alternative to alkylphenol ethoxylates that has the same or even better degreasing properties and costs the same or less and that furthermore possesses optimum biocompatibility.

We have found that this object is achieved by a degreaser for treating hides, skins, pelts and other intermediates in leather and fur manufacture and also wool or related proteinaceous materials that is based on nonionic surfactants of the type of alcohol alkoxylates, comprising alcohol alkoxylates obtained by reaction of at least one alcohol ROH with n mol of at least one alkylene oxide per mole of alcohol ROH, where

R is an alkyl radical of 5 to 30 carbon atoms which has a main chain, of 4 to 29 carbon atoms that has at least one C₁- to C₁₀-alkyl branch attached in the chain middle,

the alkylene oxide has 2 to 6 carbon atoms, and

n is an integer from 1 to 100.

The chain middle comprehends for the purposes of the present invention those carbon atoms of the main chain, i.e., of the longest alkyl chain of the radical R, beginning at the carbon atom C#2, the numbering starting with the carbon atom (C#1) that is attached directly to the oxygen atom adjacent to the radical R, and ending with the carbon atom ω-2, where ω is the terminal carbon atom of the main chain, including C#2 and the carbon atom ω-2. This means that at least one of the carbon atoms C#2, C#3 . . . to C_{ω-2} of the main chain of the radical R is substituted by a C₁- to C₆-alkyl radical. Preferably it is the carbon atom C#2 of the main chain of the radical R which is substituted by a C₁- to C₁₀-alkyl radical. But it is similarly possible for one or more carbon atoms in the chain middle to be substituted by two C₁- to C₆-alkyl radicals, i.e., for one or more carbon atoms in the chain middle to be quaternary carbon atoms.

The degreaser of the invention performs very effectively in emulsifier degreasing. It exhibits a high emulsifying effect on natural fats and oils in an aqueous medium in particular and emulsifies natural fats and oils in such a way that the fat and oil constituents can be washed off the animal hide with water.

The degreaser of the invention preferably contains a mixture of alcohol alkoxylates based on 1 to 3 different alcohols ROH, more preferably on 1 or 2 different alcohols ROH. The number of carbon atoms of the radical R may differ and/or the nature of the branching.

The number of branches on the main chain of the alcohols ROH is preferably from 1 to 4, provided the chain length allows for more than one branching in the chain middle, more preferably from 1 to 3 and most preferably 2 or 3. These branches generally each have, independently, from 1 to 10 carbon atoms, preferably from 1 to 6, more preferably from 2 to 4 and most preferably 2 or 3. Particularly preferred branches are accordingly ethyl, n-propyl or isopropyl groups.

The radical R of the alcohol ROH has 5 to 30 carbon atoms. Since the radical R has at least one branch having at least one carbon atom, the main chain numbers from 4 to 29 carbon atoms. The radical R preferably has 6 to 25 carbon atoms, more preferably 10 to 20. That is, the main chain preferably has 5 to 24 carbon atoms, more preferably 9 to 19. Most preferably, the main chain has 9 to 15 carbon atoms and the remaining carbon atoms of the radical R are accounted for by one or more branches.

The branched alcohols needed to prepare the alcohol alkoxylates used according to the invention are prepared by methods known to one skilled in the art. A general way of synthesizing branched alcohols is for example to react aldehydes or ketones with Grignard reagents (Grignard synthesis). Instead of Grignard reagents it is also possible to use aryl or alkyl lithium compounds, which are notable for higher reactivity. The branched alcohols ROH may further be obtained by aldol condensation, in which case the reaction conditions are known to one skilled in the art.

The alkylene oxide reacted with the branched alcohols ROH to form the alcohol alkoxylates used in the degreaser of the invention is preferably selected from the group consisting of ethylene oxide, propylene oxide and butylene oxide. It is also possible to react a single alcohol ROH with various of the alkylene oxides mentioned, for example ethylene oxide and propylene oxide, in which case it is possible to obtain alcohol alkoxylates which each contain blocks of multiple units of an alkylene oxide, for example ethylene oxide, alongside blocks of multiple units of a further alkylene oxide, for example propylene oxide. The alcohol alkoxylates used according to the invention particularly preferably contain ethylene oxide (EO) units; that is, the alkylene oxide used is preferably ethylene oxide.

It is also possible to obtain alcohol alkoxylates which contain various alkylene oxides, wherein the alkylene oxides are incorporated statistically, by reaction of a single alcohol ROH with various of the alkylene oxides mentioned, for example ethylene oxide and propylene oxide.

The amounts of alkylene oxide used range from 1 to 100 mol of alkylene oxide per mole of alcohol, preferably from 1 to 25 mol, more preferably from 3 to 15 mol and most preferably from 5 to 12 mol. The degree of alkoxylation obtained in the alcohol alkoxylates used according to the invention describes a broad distribution and can vary in the range from 0 to 100 mol of alkylene oxide per mole of alcohol, depending on the amount of alkylene oxide used. We have found that the molecular weight distribution which is obtained when the alcohols used according to the invention are reacted with alkylene oxides and which reflects the degree of alkoxylation of the alcohols is not gaussian. Such a gaussian distribution is obtained when oxo alcohols (industrial alcohols containing about 60% by weight of linear alcohols and about 40% by weight of methyl-branched alcohols) are alkoxylated to alcohol alkoxylates as used in prior art leather degreasers and also in the alkoxylation of alkylphenols, whose alkoxylation products have hitherto performed best in leather degreasing. The degree of alkoxylation and hence the molecular weight distribution is substantially broader in the case of the alkoxylation of the alcohols ROH used according to the invention.

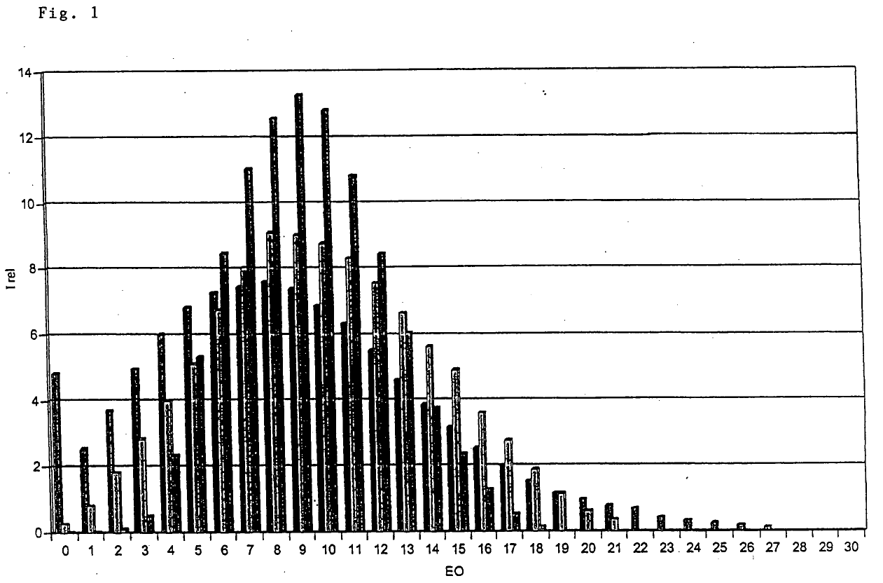

The accompanying FIG. 1 illustrates this with reference to the distribution of the degrees of ethoxylation for the example of a C10 oxo alcohol, of an alkylphenol (nonylphenol) (each comparative examples) and of a C10 alcohol branched according to the invention, which have each been ethoxylated with 8 mol of ethylene oxide per mole of alcohol (8 EO).

The abscissa of FIG. 1 is the degree of ethoxylation (EO), i.e., the number of ethylene oxide units incorporated in the alcohol, and the ordinate is the relative fraction of the respective degree of ethoxylation (relative intensity) (I rel).

In the diagram in FIG. 1, the left-hand column represents the degrees of ethoxylation of the ethoxylation of the C10 alcohol used according to the invention; the middle column represents the degrees of ethoxylation of the ethoxylation of the C10 oxo alcohol; and the right-hand column represents the degrees of ethoxylation of the ethoxylation of the alkylphenol.

It is revealed that the distribution of the degrees of ethoxylation in the case of the oxo alcohol and in the case of the alkylphenol is approximately gaussian, the distribution being broader in the case of the oxo alcohol. The fraction of unethoxylated alcohol is in both cases substantially below 1% by weight. In the case of the branched alcohol used according to the invention, however, the result is not a gaussian distribution. While degrees of ethoxylation of up to 27 are achieved (for an ethoxylation with 8 mol of EO per mole of alcohol), at the same time a considerable fraction of the alcohol is not ethoxylated at all.

The number n reported in the present application is accordingly based on the amount of alkylene oxide used.

In a preferred embodiment of the present invention, the degreaser used according to the invention contains not only alcohol alkoxylates but also >1 to 25% and preferably >1 to 10% by weight, based on the amount of alcohol alkoxylates used, of unconverted alcohol ROH.

Preference is further given to a degreaser as claimed in any of claims 1 to 6, being a mixture of alcohol alkoxylates based on at least one alcohol alkoxylate obtained by reaction of an alcohol ROH with n>6 mol, preferably from 7 to 50 mol, more preferably from 7 to 15 mol, of at least one alkylene oxide per mole of alcohol ROH and on at least one further alcohol alkoxylate obtained by reaction of an alcohol ROH with n=1 to 6 mol, preferably from 3 to 6 mol, of at least one alkylene oxide per mole of alcohol ROH, the alcohol ROH and the alkylene oxide in the at least two alcohol alkoxylates being identical or different.

In the event that the degreaser according to the invention contains a mixture of alcohol alkoxylates either constructed on the basis of different alcohols and/or reacted with a different amount or different alkylene oxides, these alcohol alkoxylates can be present in any desired ratios. When the degreaser contains for example two different alcohol alkoxylates, these may be present in ratios of from 20:1 to 1:1 and preferably from 9:1 to 1:1. In the case of three different alcohol alkoxylates it is likewise possible for one of the components to be present in excess compared with the other two components. It is likewise possible for two components to form the main fraction of the alcohol alkoxylates and for only minimal amounts to be present of the third component. It is further possible for all three components to be present in the degreaser in approximately equal fractions.

The HLB values of the alcohol alkoxylates used in the degreaser according to the invention are generally in the range from 8 to 16 and preferably in the range from 9 to 14.

The alcohol alkoxylates are prepared from the branched alcohols by reaction with alkylene oxides. The reaction conditions are known to one skilled in the art. The reaction is generally carried out over an alkali metal catalyst. It is customary to use NaOH or KOH. It is similarly possible to use Ca(OH)₂, Ba(OH)₂, Sr(OH)₂ or hydrotalcite as catalysts. The reaction is preferably carried out in the absence of water. The reaction temperature is generally in the range from 70 to 180° C.

In the reaction of an alcohol with various alkylene oxides, for example ethylene oxide and propylene oxide, the preparation of alcohol alkoxylates which each contain blocks of various alkylene oxides starts with reaction of the alcohol with a first alkylene oxide, for example propylene oxide, followed by reaction with a further alkylene oxide, for example ethylene oxide. By reaction with more than two different alkylene oxides, the other alkylene oxides are also added subsequently. It is also possible to react the product obtained by the reaction of the alcohol with a first and a second alkylene oxide and optionally further alkylene oxides again optionally with the first alkylene oxide (and subsequently with the second alkylene oxide etc.).

By use of the preferably employed alkylene oxides ethylene oxide and propylene oxide it is possible to react the alcohol at first with ethylene oxide and subsequently with propylene oxide or at first with propylene oxide and subsequently with ethylene oxide, what is preferred. In the preparation of random-mixed-alcohol alkoxylates various alkylene oxides are added at the same time, wherein again a mixture of ethylene oxide and proylene oxide is preferably employed.

The degreaser of the invention can be used at various stages in leather or fur manufacture where the use of a degreaser is sensible or required. It accordingly may be used for example in the soaking, liming, deliming, bating, pickling and/or tanning and also after any depickling, in the processing of wet blue or wet white, in the wet finishing process and in the processing of bark leathers. These individual process stages are known to one skilled in the art.

Depending on the process stage in which the degreasers of the invention are used, the degreasers can be used in combination with further components. Such components are known to one skilled in the art. Useful components include for example further formulating agents such as wetting agents, crude components having a surface-active effect, for example ether sulfates or dispersants; defoamers such as paraffins and siloxanes; carrier oils such as higher alkanes, high-aromatics vegetable or synthetic oils, white oil or mineral oil; other nonionic, anionic, cationic and/or amphoteric surfactants.

The present invention further provides a process for degreasing hides, skins, pelts or other intermediates of leather and fur manufacture or wool or related proteinaceous materials, which comprises using a degreaser according to the invention.

The degreasing process of the invention can be carried out in the float or without float. When the process is carried out without float, the degreaser of the invention is added to the hides, skins, pelts or other intermediates to be degreased and then drummed in.

The exact processing conditions depend on the process stage in which the degreaser of the invention is used. The following particulars are therefore general processing conditions without the specific aspects which must be considered in the individual process stages being more particularly discussed. They are known to one skilled in the art.

The alcohol alkoxylates present in the degreaser of the invention are generally used in an amount of from 0.5 to 5% by weight and preferably of from 1 to 3% by weight, based on the weight of the hides, skins, pelts or other intermediates of leather and fur manufacture. This relates to the total content of the alcohol alkoxylates in the degreaser of the invention. When multiple alcohol alkoxylates are used, the above-indicated ratios dictate the fraction of the individual alcohol alkoxylates. The degree of degreasing generally increases with the use level up to the specified upper limit, although the degree of degreasing depends on the natural fat content of the animal hides as well. It is not sensible to add larger amounts of alcohol alkxoylate, since there is no further improvement in the degree of degreasing or perhaps even a reduction in quality. It must further be taken into account that the saturation limit of the alcohol alkoxylate used is not exceeded.

The process of the invention is generally carried out at a pH of from 2 to 10. The pH varies with the process stage, from acidic to basic. The influence of the pH on the degree of degreasing provided by the nonionic surfactants used according to the invention is generally low.

The salt contents present during the degreasing process correspond to the salt contents customary in the various process stages. The salt content of the float is generally in the range from 0 to 100 g of NaCl/l.

The temperature of the process according to the invention is generally in the range from 15 to 45° C. and preferably in the range from 28 to 34° C. Similarly, the temperature also differs in the various process stages. For instance, post-tanning it is possible to employ higher temperatures than before, since excessive temperatures prior to tanning may impair the quality of the leathers or furs to be produced. A higher temperature generally leads to a higher degree of degreasing.

The duration of the process in turn depends on the stage in which the degreaser of the invention is used. Generally, the degreasing time will range from 0.5 hours to 10 hours, especially from 0.5 to 5 hours and more preferably from 0.5 to 3 hours. Generally, the degree of degreasing increases with increasing time, up to a maximum.

Float length should be at least such as to ensure mycelle formation, in order that the degreaser may develop its effect. A preferred way of obtaining high performance is to use multiple floats of very short length coupled with changing baths.

The degreasers of the invention provide a leather degreasing efficiency ((difference in fat content before and after degreasing)×100/(fat content before degreasing)) of ≧50% and preferably of ≧55%.

After degreasing, the degreased material is generally rinsed with water. The wastewater from the preferred emulsifier degreasing process will only contain the natural fat and surfactant substances. If desired, these substances may be removed from the aqueous phase by heating the aqueous mixture. The nonionic surfactants used according to the invention lose solubility at elevated temperature. The subsequent loss of emulsifier effect results in a separation of the emulsion. Processes for separating the water from the natural fat and the surfactant are known to one skilled in the art.

The present invention further provides for the use of the degreaser used according to the invention for degreasing hides, skins, pelts and other intermediates of leather and fur manufacture and also wool or related proteinaceous materials.

The examples hereinbelow illustrate the invention.

### EXAMPLES

1. Preliminary Tests

Initial, preliminary tests were carried out of the emulsifying effect of different surfactants on natural fats (pigfat, beef tallow). It was found that both in pure tap water (6° German hardness) and under the float conditions customary for leather degreasing (salt content 0-100 g of NaCl/l and pH 2-10) alkylphenol ethoxylate with 9 ethylene oxide (EO) units gave the best result, followed by the inventive degreaser based on branched alcohols having an alkyl radical R of 10 carbon atoms which had been reacted with 3, 5, 7, 8, 9, 10 and 14 mol of ethylene oxide (EO) per mole of alcohol. Some distance behind were products based on oxo alcohols (alcohol ethoxylates with 12-13 EO units).

The alcohol ethoxylates of the invention as well as the alkylphenol ethoxylates mostly provided very finely divided and stable emulsions, finely divided emulsions being indicative of a good degreasing result.

2. Tests in a Tanning Plant Under Conditions Close to Actual Service

Tests were carried out in a tanning plant under conditions close to actual service on the surfactants mentioned in sole use and in mixtures not only on a purely nonionic basis but also as a blend with anionic surfactants (e.g., dioctyl sulfosuccinate).

To this end, pickled sheepskins from New Zealand were initially depickled in an aqueous medium using sodium carbonate and sodium chloride, then defleshed and floatlessly drummed with different surfactants. This was followed by washing with water and a further repeat of the degreasing process described. After thorough washing, the pelts were tanned and finished.

The pelt samples taken before and after degreasing were then dried and treated with dichloromethane in the lab. The degreasing efficiency was then calculated from the starting fat content and the post-degreasing fat content.

Table 1 shows comparisons of the efficiencies achieved in leather degreasing using oxo alcohol ethoxylates and alkylphenol ethoxylates compared with ethoxylates of the branched alcohols ROH used according to the invention.

TABLE 1

| | | Efficiency |
|---|---|---|
| Test | Surfactant(s) | [%] |
| IV¹⁾ | Nonylphenol ethoxylate with 3 EO/9 EO²⁾ | about 50 |
| 1 | Branched C10 alcohol ethoxylate with 3 EO/9 EO²⁾ | about 60 |
| 2V¹⁾ | Nonylphenol ethoxylate with 9 EO²⁾ | about 60 |
| 2 | Branched C10 alcohol ethoxylate with 9 EO³⁾ | about 60 |
| 3V¹⁾ | C10 oxo alcohol with 7 EO³⁾ | about 40 |
| 3 | Branched C10 alcohol ethoxylate with 7 EO³⁾ | about 55 |
| 4V¹⁾ | C13 oxo alcohol with 3 EO/8 EO²⁾ | about 30 |
| 4 | Branched C10 alcohol ethoxylate with 3 EO/9 EO²⁾ | about 60 |

¹⁾comparative test
²⁾mixture of 2 alcohol ethoxylates by reaction of the same alcohol (or alkylphenol) with different amounts of ethylene oxide
³⁾alcohol ethoxylate by reaction of the corresponding alcohol (or alkylphenol) with the corresponding amount of ethylene oxide

As is discernible from a comparison of the two comparative tests based on nonylphenol ethoxylate (V1 and V2), the leather degreasing efficiency decreased on using nonylphenol ethoxylates obtained by reaction of nonylphenol with different amounts of ethylene oxide (3 EO/9 EO) compared with nonylphenol ethoxylate obtained by reaction of nonylphenol with a specific amount of ethylene oxide (9 EO). The expectation accordingly was that a broad molecular weight distribution (that is, a broad ethylene oxide distribution) results in a worse efficiency. However, it was found that the alcohol alkoxylates used according to the invention, which had a very broad molecular weight distribution, provided excellent efficiencies in leather degreasing. This was also surprising in the light of the molecular weight distributions shown in FIG. 1. In FIG. 1, the alkylphenol alkoxylate possessing the best degreasing properties in the prior art has the narrowest molecular weight distribution. The oxo alcohol alkoxylates having worse properties in leather degreasing by contrast possess a broader molecular weight distribution. The broadest molecular weight distribution (departing from gaussian) is exhibited by the alcohol alkoxylates used according to the invention. These, however, surprisingly exhibit outstanding properties in leather degreasing.

Table 2 below recites alcohol alkoxylates used according to the invention and the corresponding efficiencies in leather degreasing.

TABLE 2

| | | Efficiency |
|---|---|---|
| Test | Surfactant(s) | [%] |
| 5 | Branched C10 alcohol ethoxylate with 9 EO/10 EO¹⁾ | about 65 |
| 6 | Branched C10 alcohol ethoxylate with 10 EO²⁾ | about 60 |
| 7 | Branched C10 alcohol ethoxylate with 3 EO²⁾ | about 50 |
| 8 | Branched C11 alcohol ethoxylate with 11 EO²⁾ | about 60 |
| 9 | Branched C10 and C11 alcohol ethoxylate with 7° | about 65 |
| | EO and 9° EO³⁾ | |
| 10 | Branched C10-alcohol alkoxylate with 1 | about 65 |
| | PO and 4EO⁴⁾ | |
| 11 | Branched C10-alcohol alkoxylate with 2 | about 60 |
| | PO and 5 EO⁴⁾ | |
| 12 | Branched C10-alcohol alkoxylate with 2 | about 65 |
| | PO and 6 EO⁴⁾ | |
| 13 | Branched C10-alcohol alkoxylate with 3 | about 55 |
| | PO and 6 EO⁴⁾ | |
| 14 | Branched C11-alcohol alkoxylate with 2 | about 60 |
| | PO and 7 EO⁴⁾ | |
| 15 | Branched C10-alcohol alkoxylate with 1 | about 65 |
| | PO and 6 EO⁴⁾ | |
| 16 | Branched C10-alcohol alkoxylate with 7 | about 50 |
| | EO and 7 PO⁴⁾ | |
| 17 | Branched C11-alcohol alkoxylate with 7 | about 55 |
| | EO and 7 PO⁴⁾ | |
| 18 | Branched C11-alcohol alkoxylate with 7 | about 50 |
| | EO and 7 PO (random)⁵⁾ | |
| 19 | Branched C11-alcohol alkoxylate with 6 | about 55 |
| | EO and 3 PO⁴⁾ | |
| 20 | Branched C10-alcohol alkoxlate with 3 | about 65 |
| | EO and 1 PO⁴⁾ | |
| 21 | Branched C10-alcohol alkoxylate with 6 | about 55 |
| | EO and 4 PO⁴⁾ | |
| 22 | Branched C10-alcohol alkoxylate with 6 | about 60 |
| | EO and 2 PO (random)⁵⁾ | |
| 23 | Branched C10-alcohol alkoxylate with 6 | about 55 |
| | EO and 2 PO⁴⁾ | |
| ¹⁾mixture of 2 alcohol ethoxylates by reaction of the same alcohol with different amounts of ethylene oxide | | |
| ²⁾alcohol ethoxylate by reaction of the corresponding alcohol with the corresponding amount of ethylene oxide | | |
| ³⁾mixture from the reaction of two different alcohols each reacted with different amounts of ethylene oxide | | |
| ⁴⁾alcohol alkoxylate by reaction of an alcohol with two different alkoxylates (EO = ethylene oxide and PO = propylene oxide), wherein the alcohol alkoxylate comprises blocks of the different alkoxylates; | | |
| # the order of PO and EO in the surfactant is the order of the addition of PO and EO in the preparation of the alcohol alkoxylate (this means: 1 PO and 4 EO has the following meaning: In the preparation of the alcohol alkoxylate PO is added at first and EO is added subsequently) | | |

⁵⁾alcohol alkoxylate by reaction of an alcohol with two different alkoxylates, wherein the alkylene oxides are incorporated statistically into the alcohol alkoxylate (random-mixed-alcohol alkoxylates)

3. Comparison of Alcohol Alkoxylates Used According to the Invention with Alkylphenol Ethoxylates Used in Prior Art

The % ages in the examples which follow are by weight, based on the pelt weight.

### Example 3a) (Comparative)

A sheep pickle pelt (New Zealand) was drummed in 150% of water with 10% of sodium chloride and 1.5% of sodium carbonate for 1 hour and then defleshed. A sample of the pelt was cut off for fat analysis. The pelt was then drummed with 1.5% of alkylphenol ethoxylate (9 EO), 100% of water at 30° C. was added after 60 minutes and drumming was continued for 30 minutes. The float was dropped, 1% of alkylphenol ethoxylate (9 EO) was added and drummed in for 60 minutes. At the end of this period, another 100% of water at 30° C. was added and drummed in for a further 30 minutes. The float was then discarded and the pelt washed three times with 150% of water at 30° C. each time. Another sample was then cut off from the pelt. The pelts thus degreased were then drummed with 40% of water and 5% sodium chloride for 10 minutes, then admixed with 1% of formic acid followed by 0.5% of sulfuric acid after a further 30 minutes and drummed for 120 minutes. This was followed by the addition of 6% of Chromitan FM® and, after 120 minutes, neutralization with Neutrigan MON®.

The fat content was 21% before and 7.7% after degreasing.

The efficiency is accordingly:
(21−7.7)×100/21=63%

### Example 3b) (Inventive)

Example 1 was repeated except that alkylphenol ethoxylate (9 EO) was replaced in each case by a branched C10 alcohol ethoxylate (reaction of C10 alcohol with 9 mol of EO per mole of alcohol).

The fat content was 23.4% before and 8.9% after degreasing.

The efficiency is accordingly:
(23.4−8.9)×100/23.4=62%

### Example 3c) (Comparative)

Example 1 was repeated except that the 1.5% and 1% of alkylphenol ethoxylate (9 EO) was replaced in each case by 3% of a mixture of 40 parts by weight of alkylphenol ethoxylate (9 EO), 15 parts by weight of alkylphenol ethoxylate (3 EO) and 40 parts of dioctyl sulfosuccinate.

The fat content was 25.3% before and 11.1% after degreasing.

The efficiency is accordingly:
(25.3−11.1)×100/25.3=56.1%

### Example 3d) (Inventive)

Example 1 was repeated except that the alkylphenol ethoxylate (9 EO) was replaced in each case by 3% of a mixture of 40 parts by weight of branched C10 alcohol ethoxylate (reaction of C10 alcohol with 9 mol of EO per mole of alcohol), 15 parts of branched C10 alcohol ethoxylate (reaction of C10 alcohol with 3 mol of EO per mole of alcohol) and 40 parts of dioctyl sulfosuccinate.

The fat content was 22.7% before and 8.7% after degreasing.

The efficiency is accordingly:
(22.7−8.7)×100/22.7=61.7%

1-13. (canceled)

14. A degreaser for treating hides, skins, pelts and other intermediates in leather and fur manufacture and also wool or related proteinaceous materials that is based on nonionic surfactants of the type of alcohol alkoxylates, comprising alcohol alkoxylates obtained by reaction of at least one alcohol ROH with n mol of at least one alkylene oxide per mole of alcohol ROH, where
R is an alkyl radical of 5 to 30 carbon atoms which has a main chain, which is the longest alkyl chain of the radical R, of 4 to 29 carbon atoms that has at least one C₁- to C₁₀-alkyl branch attached in the chain middle, beginning at the carbon atom C#2, the numbering starting with the carbon atom (C#1) that is attached directly to the oxygen atom adjacent to the radical R, and ending with the carbon atom ω-2, where w is the terminal carbon atom of the main chain, including C#2 and the carbon atom ω-2,
the alkylene oxide has 2 to 6 carbon atoms, and
n is an integer from 1 to 100.

15. A degreaser as claimed in claim 14, comprising a mixture of alcohol alkoxylates based on 1 to 3 different alcohols ROH.

16. A degreaser as claimed in claim 14, wherein the main chain has at least one C₂- to C₄-alkyl radical branch attached in the chain middle.

17. A degreaser as claimed in claim 14, wherein the radical R has 10 to 20 carbon atoms, of which 9 to 19 carbon atoms form the main chain.

18. A degreaser as claimed in claim 14, wherein the alkylene oxide is ethylene oxide.

19. A degreaser as claimed in claim 14, wherein n is an integer from 3 to 15.

20. A degreaser as claimed in claim 14, being a mixture of alcohol alkoxylates based on at least one alcohol alkoxylate obtained by reaction of an alcohol ROH with n>6 mol of at least one alkylene oxide per mole of alcohol ROH and on at least one further alcohol alkoxylate obtained by reaction of an alcohol ROH with n=1 to 6 mol of at least one alkylene oxide per mole of alcohol ROH, the alcohol ROH and the alkylene oxide in the at least two alcohol alkoxylates being identical or different.

21. A degreaser as claimed in claim 14, comprising as well as the alcohol alkoxylates >1 to 25% by weight, based on the amount of alcohol alkoxylates used, of unconverted alcohol ROH.

22. A process for degreasing hide, skins, pelts and other intermediates of leather and fur manufacture and wool or related proteinaceous materials, which comprises using a degreaser as claimed in claim 14.

23. A process as claimed in claim 22, wherein the alcohol alkoxylates are used in an amount of from 0.5 to 5% by weight, based on the weight of the hides, skins, pelts or other intermediates of leather and fur manufacture or wool or related proteinaceous materials.

24. A process as claimed in claim 22, further comprising setting a temperature of from 15 to 45° C.

25. A degreaser as claimed in claim 14, wherein the alcohol alkoxylate is obtained by reaction of an alcohol with ethylene oxide and propylene oxide.
